(19) United States
(12) Patent Application Publication
(10) Pub. No.: US 2018/0213712 A1
(43) Pub. Date: Aug. 2, 2018

(54) Cultivator Assembly

(71) Applicant: James F. Kline, Cicero, NY (US)

(72) Inventor: James F. Kline, Cicero, NY (US)

(73) Assignee: James F. Kline, Cicero, NY (US)

(21) Appl. No.: 15/417,693

(22) Filed: Jan. 27, 2017

(51) Int. Cl. A01B 63/22; A01B 49/02

(52) U.S. Cl. CPC A01B 63/22; A01B 63/32; A01B 49/02

(57) ABSTRACT

A cultivator assembly having multiple interchangeable implements and adapted to be towed behind an ATV type (off-road) vehicle so that food plots or other land working tasks can be quickly accomplished. The cultivator assembly generally includes an implement trailer adapted to be towed behind an off-road vehicle, a transport trailer for moving the implement trailer to a cultivation site, and a hitch assembly for attaching the implement trailer to either an on-road vehicle or an off-road vehicle.

### REFERENCE TO RELATED APPLICATION

N/A

### BACKGROUND

### 1. Field of Invention

The present invention relates generally to cultivating equipment and more particularly to an off-road tow-behind trailer having multiple cultivating instruments that can be deployed and an assembly that further includes a transport trailer and hitch assembly for attaching to on-road vehicles as well as off-road vehicles.

### 2. Background of Art

Ground cultivating machines are well known. Most include some form of chassis adapted to be towed behind a vehicle and that include cultivating tools depending therefrom. Some cultivating machines are used by hunters to prepare food plots to assist in bringing deer or other animals into a predefined space. As the food plots are often located in areas inaccessible to trucks or other road vehicles, the cultivating machine must be transported to the space using off-road type vehicles, such as ATVs. Thus, it would be beneficial to have a versatile cultivating machine that can be towed by a road vehicle and then removed from the road vehicle and attached for towing behind an off road vehicle.

### 3. Objects and Advantages

It is therefore a principal object and advantage of the present invention to provide a cultivating assembly useful for preparing food plots.

It is another object and advantage of the present invention to provide a cultivating assembly that is versatile and permits various cultivating tools to be used.

It is a further object and advantage of the present invention to provide a cultivating assembly that may be towed behind both a road vehicle and an off-road vehicle.

Other objects and advantages of the present invention will in part be obvious and in part appear hereinafter.

### SUMMARY OF THE INVENTION

In accordance with the foregoing objects and advantages, the present invention provides a cultivator having multiple interchangeable implements. The cultivator is adapted to be towed behind an ATV type (off-road) vehicle so that food plots or other land working tasks can be quickly accomplished.

In one embodiment, the present invention provides a cultivator assembly, comprising an implement trailer extending along a longitudinal axis and having a forward end and a rearward end; a first support arm attached to the forward end of the implement trailer and extending along the longitudinal axis; a second support arm attached to the rearward end of the implement trailer and extending along the longitudinal axis; a first set of cultivating tools adapted for removable attachment to the first support arm; a second set of cultivating tools adapted for removable attachment to the second support arm; a stanchion attached to and extending upwardly from the implement trailer; first and second actuators attached between the implement trailer and the stanchion and being selectively actuable to raise and lower the implement trailer; and a set of wheels attached to the implement trailer.

In one aspect, the present invention further comprises a trailer adapted for carrying the implement trailer thereon.

In another aspect, the present invention further comprises a hitch assembly adapted for removable attachment to the first support arm. The hitch assembly comprises a first section adapted for removable attachment to the first support arm, and a second section movably linked to said first section and adapted for removable attachment to a vehicle, and a third actuator extending between the first and second sections and adapted to selectively raise and lower the second section relative to the first section.

### BRIEF DESCRIPTION OF THE DRAWINGS

The present invention will be more fully understood and appreciated by reading the following Detailed Description in conjunction with the accompanying drawings, in which:

FIG. 1 is a side elevation view of a cultivator assembly in accordance with an embodiment of the present invention.

FIG. 2 is a side elevation view of a transport trailer.

FIGS. 3A and 3B are a side elevation view and a top plan view, respectively, of an implement trailer.

FIG. 4 is a top plan view of a transport trailer.

FIGS. 5 and 6 are top plan and side elevation views of an implement trailer in accordance with an aspect of the invention.

FIG. 7 is a side elevation view of an implement trailer in accordance with an aspect of the invention.

FIGS. 8A-8C are rear elevation views of an implement trailer with the axles in different orientations.

FIGS. 9 and 10 are top plan and side elevation views of an implement trailer in accordance with an aspect of the invention.

FIGS. 11 and 12 are top plan and side elevation views of an implement trailer in accordance with an aspect of the invention.

FIGS. 13 and 14 are top plan and side elevation views of an implement trailer in accordance with an aspect of the invention.

FIGS. 15 and 16 are top plan and side elevation views of an implement trailer in accordance with an aspect of the invention.

FIGS. 17 and 18 are top plan and side elevation views of an implement trailer in accordance with an aspect of the invention.

FIGS. 19 and 20 are top plan and side elevation views of an implement trailer in accordance with an aspect of the invention.

FIGS. 21 and 22 are top plan and side elevation views of an implement trailer in accordance with an aspect of the invention.

FIG. 23 is an exploded perspective view of a power supply in accordance with an aspect of the invention.

FIG. 24 is a top plan view of an implement trailer and the collection of exemplary cultivating tool attachments that may be mounted thereto.

FIG. 25 is a perspective view of a power supply in accordance with an aspect of the invention.

### DETAILED DESCRIPTION

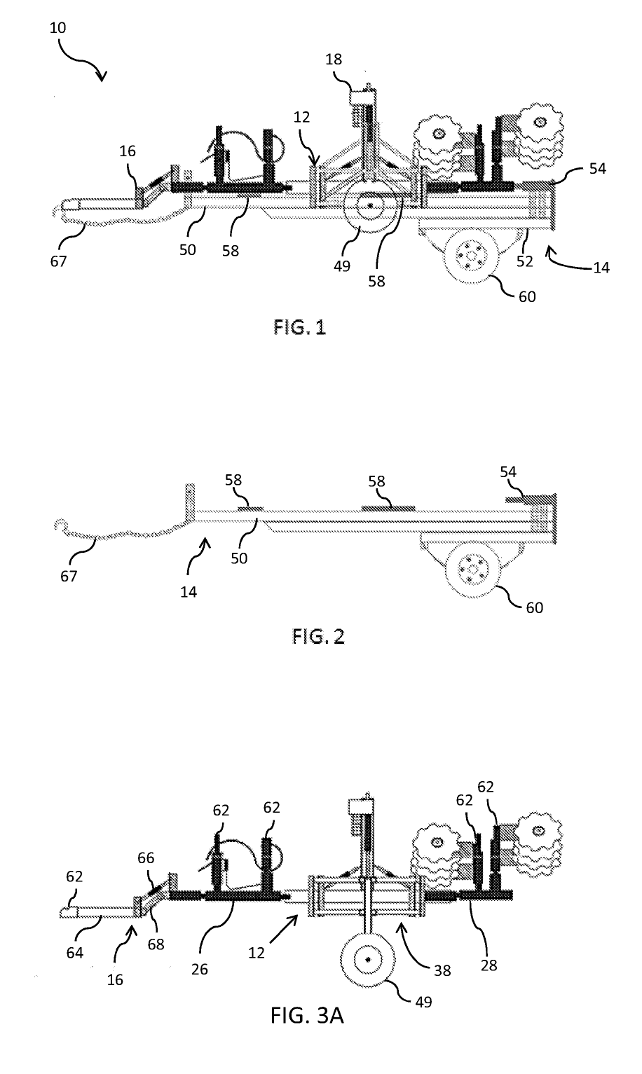

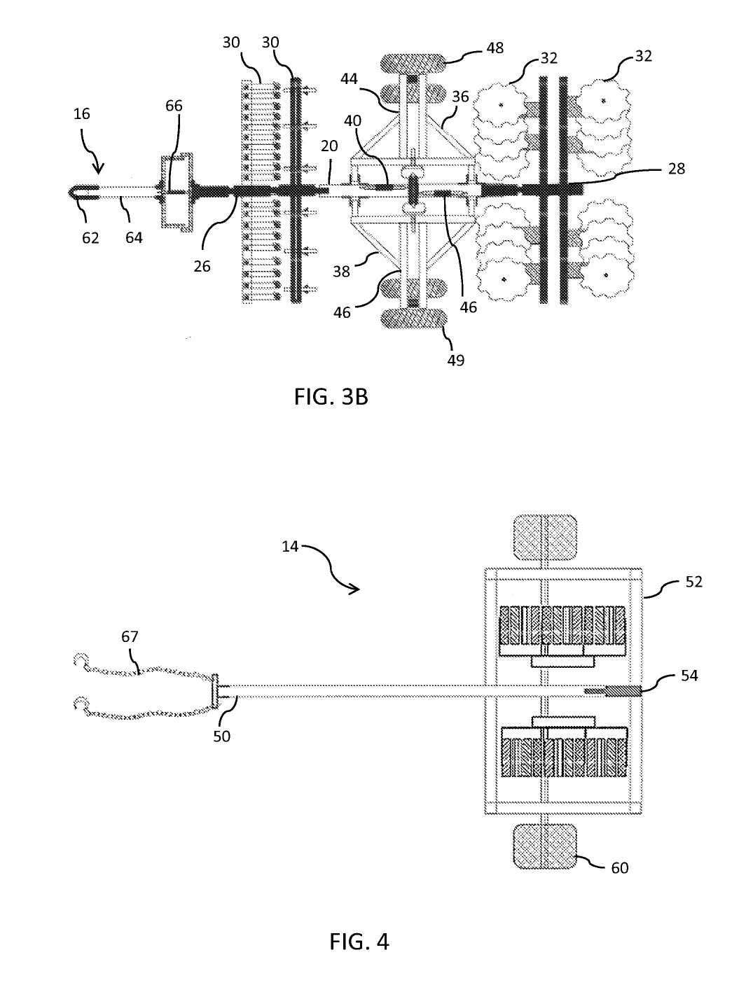

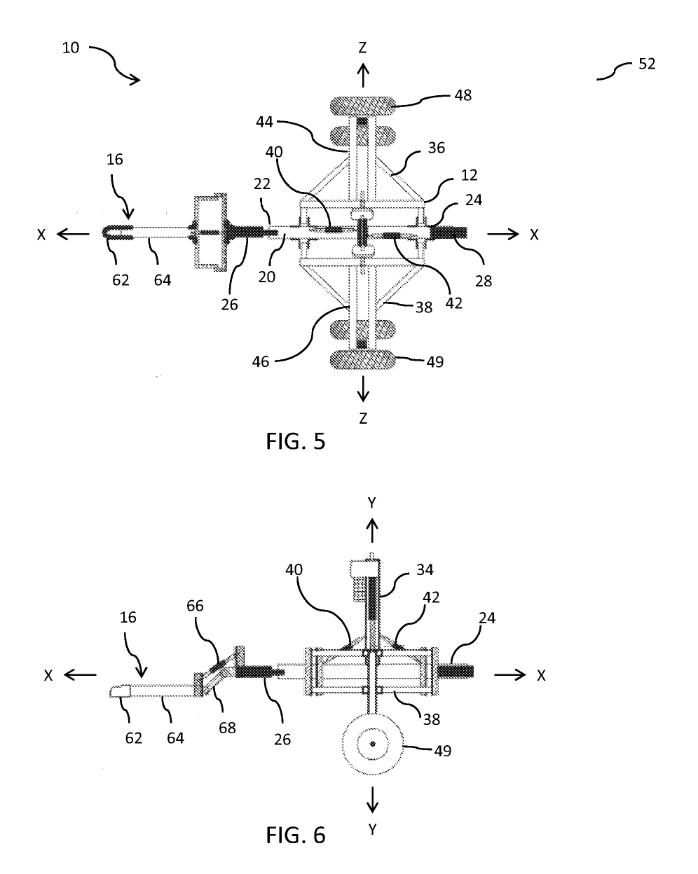

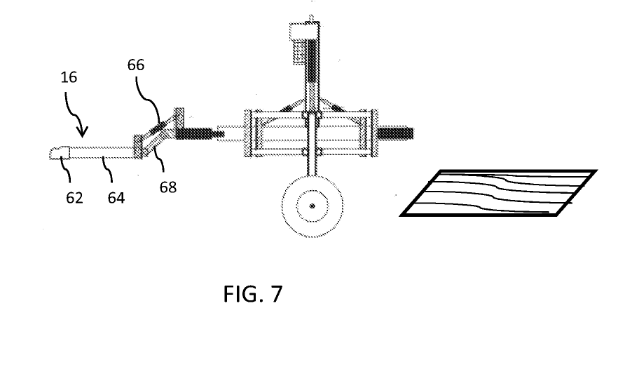

Referring to the drawings, wherein like reference numerals refer to like parts throughout, there is seen in FIG. 1 a cultivator assembly, designated generally by reference numeral 10, for towing behind an ATV, tractor, or like vehicle (not shown) for use in cultivating food plots for use in hunting, garden plots, or other purposes. Cultivator assembly 10 has three primary components: an implement trailer 12 for use in cultivating the land and being towed behind an ATV type vehicle, a transport trailer 14 for carrying the implement trailer 12 thereon when transporting by truck or other typical vehicle, and a hitch assembly 16 for interconnecting implement trailer 12 to the ATV type vehicle. An external power supply 18 can also be supplied with cultivator assembly 12 for purposes that will be explained hereinafter.

Implement trailer 12 comprises a central support tube 20 that extends along longitudinal axis X-X and that includes a forward end 22 and a rearward end 24. A first implement support arm 26 is removably attached to the forward end 22, and a second implement support arm 28 is remoavbly attached to the rearward end 24. First implement support arm 26 is adapted to have a first set of cultivating tools 30 removably mounted thereon, while second implement support arm 28 is adapted to have a first set of cultivating tools 32 removably mounted thereon (first set of cultivating tools 30 and second set of cultivating tools 32 may be the same or different types of tools). A stanchion 34 is attached to support tube 20 and extends vertically upward therefrom along axis Y-Y that is perpendicular to axis X-X and is positioned at about the mid-point of tube 20. Rigidly attached to each side of support tube 20 is a double-A shaped truss 36, 38, respectively, each of which is also selectively movably interconnected to stanchion 34 by way of respective actuators 40, 42 that extend therebetween. Actuators 40, 42 are controlled by power supply 18 and comprise a piston and cylinder arrangement that permits selective raising and lowering of implement trailer 12. Finally, axle assemblies 44, 46 extend off of stanchion 34 along axis Z-Z that is perpendicular to axes X-X and Y-Y and have wheel sets 48 and 49, respectively, mounted on opposite ends thereof. The selective raising and lowering of implement trailers by way of actuators 40, 42 permit implement trailer 12 to be raised for positioning on trailer 14 and lowered for use in cultivating land.

Cultivator assembly 10 further comprises the transport trailer 14 that is towable behind a truck or other road vehicle and used to transport implement trailer 12 to a cultivation site. Trailer 14 comprises an elongated center support member 50 that extends along axis A-A (which would be coincident with axis X-X when implement trailer 12 is mounted upon trailer 14) and is attached to a trailer frame 52 that is sized to receive and support trusses 36, 38 thereon. A rear socket 54 is mounted at the rear end of trailer 14, extends along an axis that is coincident with axis X-X when implement trailer 12 is mounted thereon and is adapted to receive rear implement support arm 28 therein to further stabilize the connection between implement trailer 12 and transport trailer 14. A front socket 56 is mounted at the front end of trailer 14 and is aligned with and adapted to receive first implement support arm 26 therein to again further the supportive interconnection between trailers 12 and 14. Several pads 58 are mounted along center support member 50 to provide a buffer for the components of trailer 12 that may bump into or vibrate with support member 50 when travelling. Wheels 60 are attached to frame 52 in a typical fashion.

Hitch assembly 16 comprises a tongue 62 adapted for engagement with a standard vehicle mounted ball hitch (not shown). Tongue 62 is positioned at the end of a hitch bar 64 that is movably attached to implement trailer 12 by way of an actuator 66 and pivotal linkage 68. Power supplied to actuator 66 will pivotally raise or lower the tongue 62 relative to the ball hitch of a transport vehicle that will transport the trailer assembly to cultivation site and then to the ball hitch on an ATV that will pull the implement trailer when in use. A hook and chain assembly 67 is provided on transport trailer 14 to interconnect to tongue 62 and secure the interconnection between trailers 12 and 14.

When transporting implement trailer 12, additional cultivator tool sets can be attached thereto by way of additional implement supports 70 that modularly attach to and extend upwardly from support tube 20.

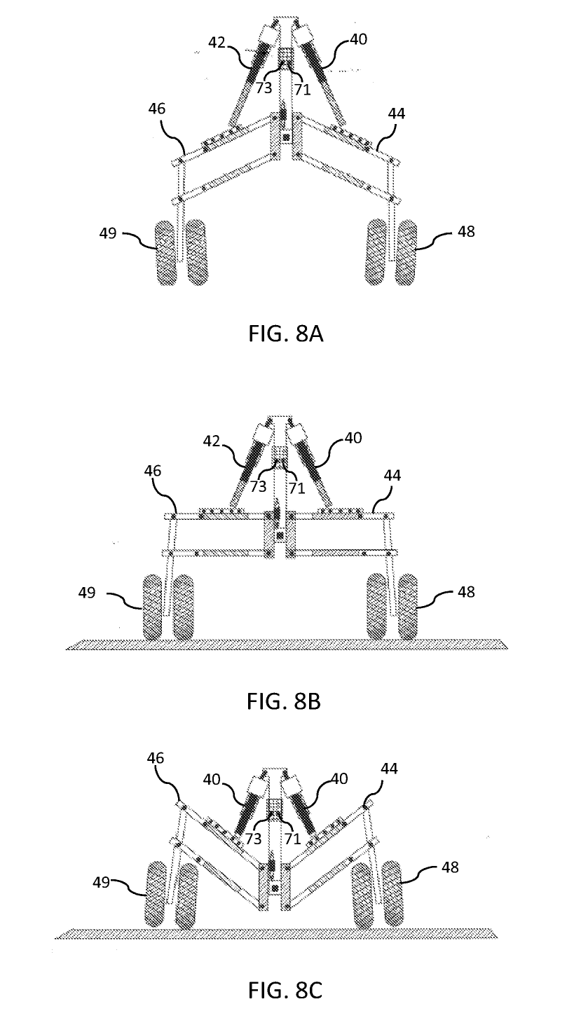

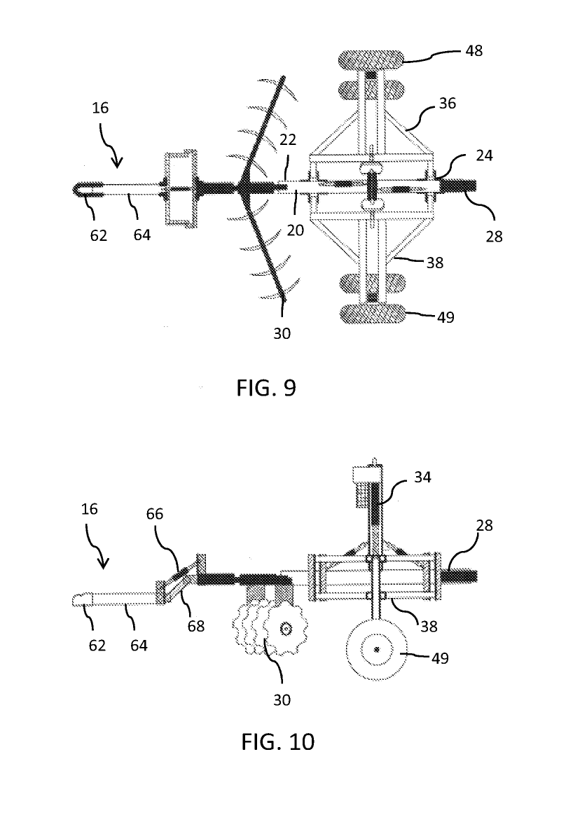

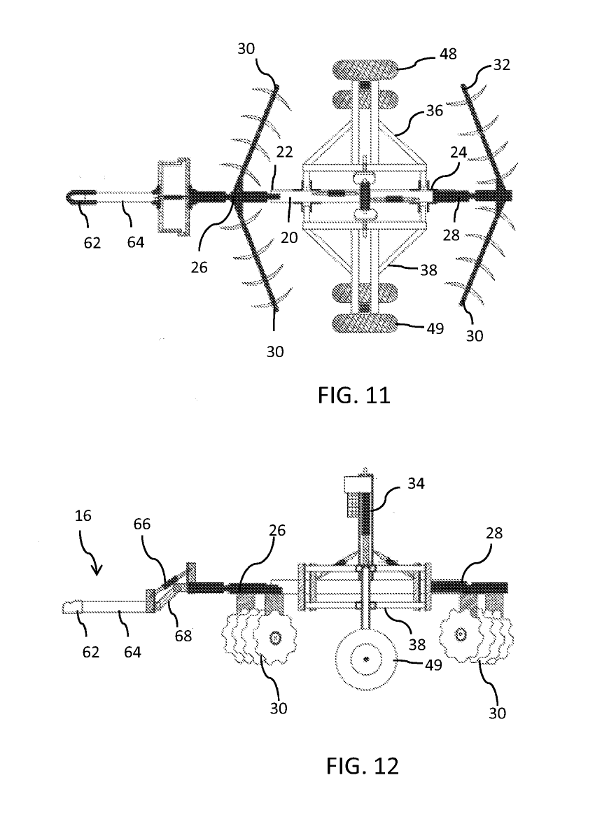

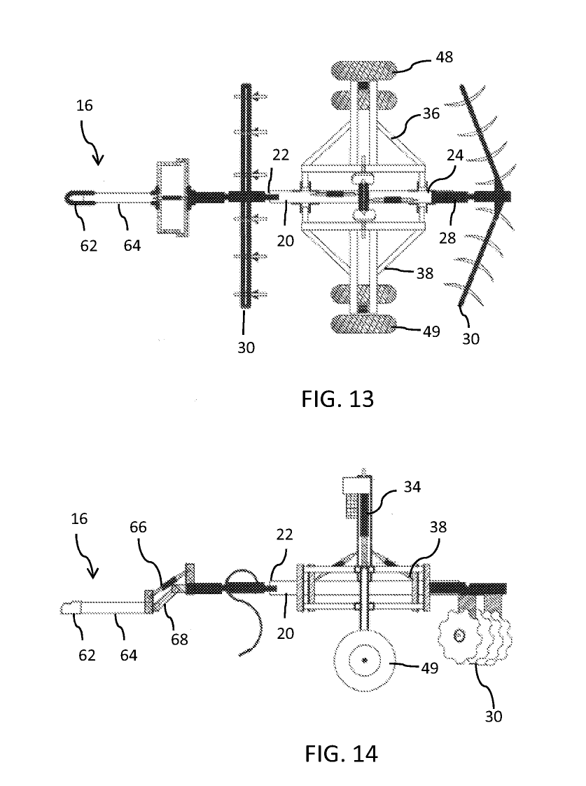

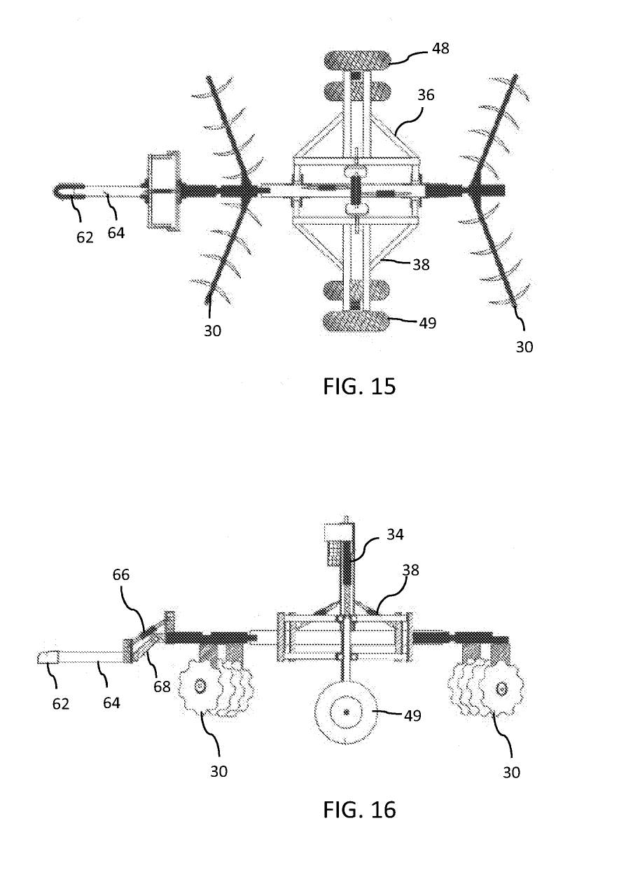

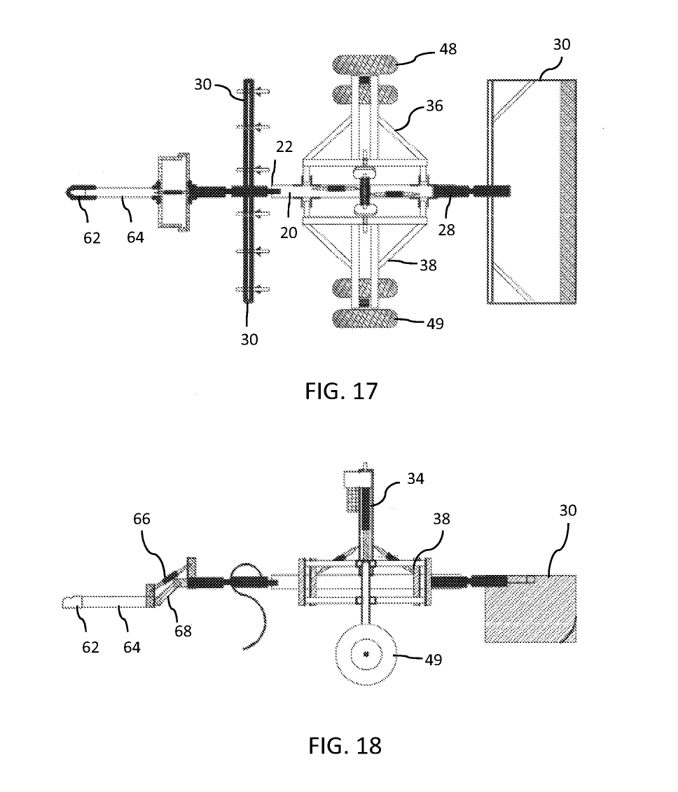

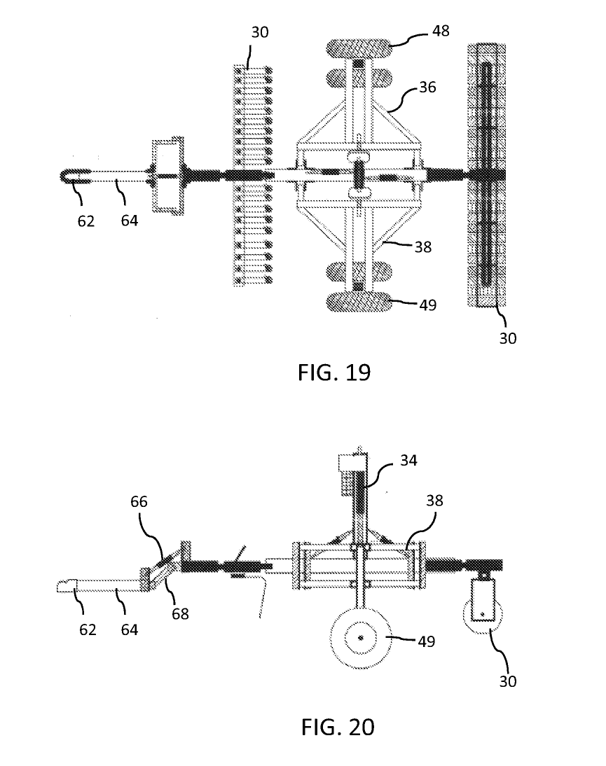

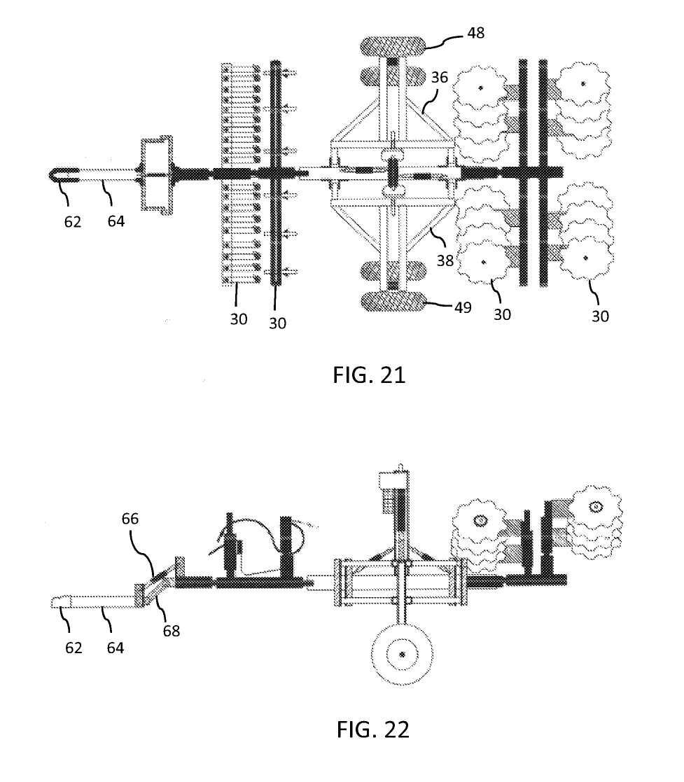

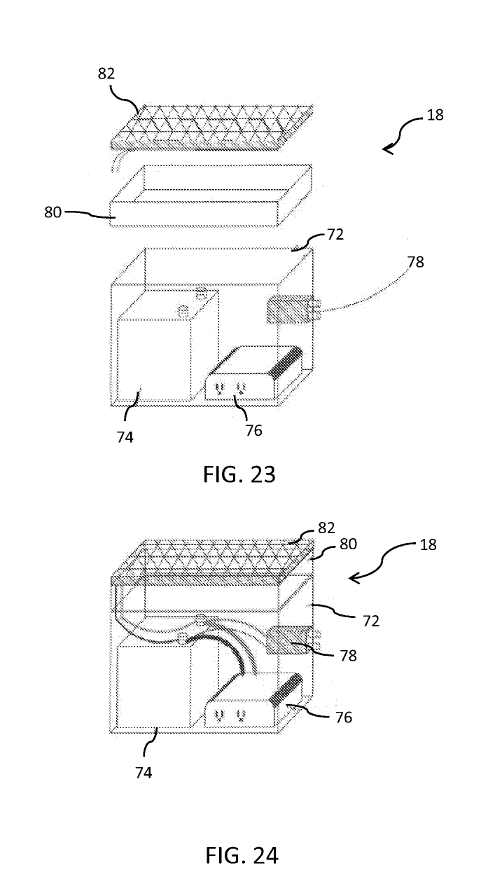

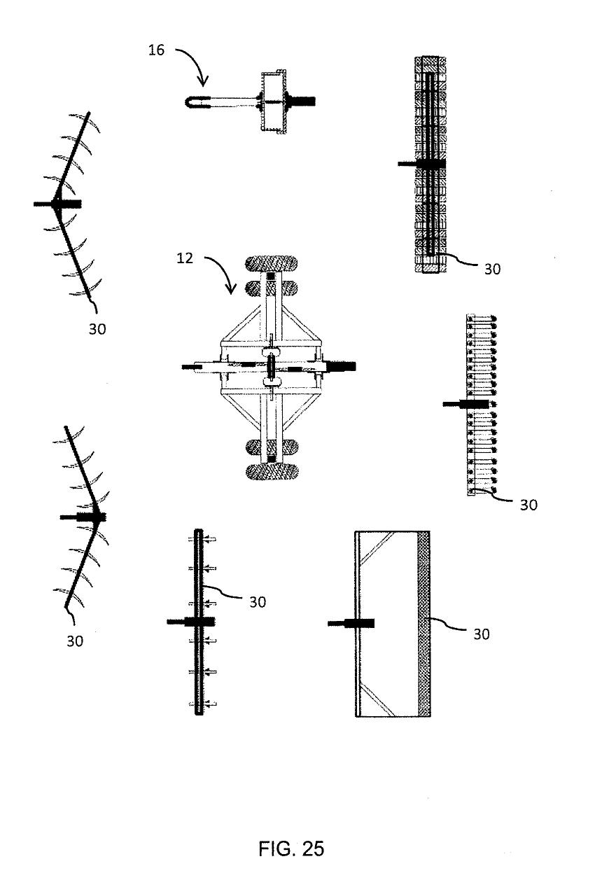

Power supply 18 can be attached to trailer assembly 10 and used in connection with the power take-off of the ATV or other vehicle to provide power to the actuators 40, 42, and 66. Each of the actuators is independently controlled by a switch 71, 73, thereby permitting any one of them to cause movement to the portion of assembly 10 to which it is connected. Thus, actuator 42 may be powered while actuator 44 is not to provide an orientation that tilts the implement trailer 12 (which might be necessary or desirable if cultivating a hillside). Or both actuators 42, 44 can be powered simultaneously to raise or lower the trailer 12 when, for example, clearing tree trunks or other objects lying on the ground and/or raising the wheels 50 for placement of the trailer 12 onto trailer 14. The various orientations of trailer 12 shown in FIGS. 8A-8C are exemplary of the independent control provided by actuators 42, 44 (with the understanding that any other number of orientations could likewise be achieved).

Power supply comprises a container 72 in which a battery 74, inverter 76, and charging connector 78 are contained. A tool tray 80 sits in covering relation to the container 72 and provides space for various tools to be stored. Finally, a solar cover 82 covers tray 80 and is used to collect solar energy and then have that energy converted into electrical energy to provide power to the actuators. Alternatively, the power take-off from any vehicle can be used to supply the power.

Cultivating tools 30 can comprise any number of configurations including, for example, discs, a harrow, a yard rake, a box blade, and/or a packer/roller.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto; embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A cultivator assembly, comprising:
a. an implement trailer extending along a longitudinal axis and having a forward end and a rearward end and comprising:
i. a first support arm attached to said forward end of said implement trailer and extending along said longitudinal axis;
ii. a second support arm attached to said rearward end of said implement trailer and extending along said longitudinal axis;
iii. a stanchion attached to and extending upwardly from said implement trailer;
iv. first and second actuators attached between said implement trailer and said stanchion and being selectively actuable to raise and lower said implement trailer; and
v. a set of wheels attached to said implement trailer;
b. a trailer adapted for carrying said implement trailer thereon; and
c. a hitch assembly adapted for removable attachment to said first support arm.

2. The cultivator assembly according to claim 1, wherein said hitch assembly comprises a first section adapted for removable attachment to said first support arm, and a second section movably linked to said first section and adapted for removable attachment to a vehicle, and a third actuator extending between said first and second sections and adapted to selectively raise and lower said second section relative to said first section.

3. The cultivator assembly according to claim 1, wherein said implement trailer further comprises:
i. a first set of cultivating tools adapted for removable attachment to said first support arm; and
ii. a second set of cultivating tools adapted for removable attachment to said second support arm.

4. The cultivator assembly according to claim 1, further comprising a power supply assembly attached to said implement trailer.

5. The cultivator assembly according to claim 4, wherein said power supply assembly comprises a container, and a batter, inverter and charging connector all housed within said container.

6. The cultivator assembly according to claim 5, wherein said power supply assembly further comprises a tool tray that is positioned in at least partially covering relation to said container.

7. The cultivator assembly according to claim 5, wherein said power supply assembly further comprises a cover to be placed above said housing and having solar energy collection cells incorporated therein.

8. An implement trailer extending along a longitudinal axis and having a forward end and a rearward end, comprising:
a. a first support arm attached to said forward end of said implement trailer and extending along said longitudinal axis;
b. a second support arm attached to said rearward end of said implement trailer and extending along said longitudinal axis;
c. a stanchion attached to and extending upwardly from said implement trailer;
d. first and second actuators attached between said implement trailer and said stanchion and being selectively actuable to raise and lower said implement trailer; and
e. a set of wheels attached to said implement trailer.

9. The implement trailer according to claim 8, further comprising:
a. a first set of cultivating tools adapted for removable attachment to said first support arm; and
b. a second set of cultivating tools adapted for removable attachment to said second support arm.

10. The cultivator assembly according to claim 8, further comprising a power supply assembly attached to said implement trailer.

11. The cultivator assembly according to claim 10, wherein said power supply assembly comprises a container, and a batter, inverter and charging connector all housed within said container.

12. The cultivator assembly according to claim 11, wherein said power supply assembly further comprises a tool tray that is positioned in at least partially covering relation to said container.

13. The cultivator assembly according to claim 11, wherein said power supply assembly further comprises a cover to be placed above said housing and having solar energy collection cells incorporated therein.
